(19) United States
(12) Patent Application Publication
(10) Pub. No.: US 2004/0089980 A1
(43) Pub. Date: May 13, 2004

(54) Three-dimensional fabrication method and apparatus

(75) Inventor: Koji Owada, Shizuoka (JP)

Correspondence Address: GREENBLUM & BERNSTEIN, P.L.C., 1950 ROLAND CLARKE PLACE, RESTON, VA, 20191, US

(73) Assignee: Roland DG Corporation, Shizuoka-ken (JP)

(21) Appl. No.: 10/369,696

(22) Filed: Feb. 21, 2003

(30) Foreign Application Priority Data
Nov. 13, 2002 (JP) 2002-329102

(51) Int. Cl. B29C 41/02

(52) U.S. Cl. 264/308; 425/174.4; 425/375; 425/166

(57) ABSTRACT

A three-dimensional fabrication apparatus and method for constructing a three-dimensional object to a desired shape. The method includes forming a first type of material layer with a first media application device, machining the first type of material layer, forming a second type of material layer with a second media application device, machining the second type of material layer, and creating a finished three-dimensional object by repeating the forming and the machining of the first and second types of material layers.

### CROSS-REFERENCE TO RELATED APPLICATION

The present application claims priority under 35 U.S.C. § 119 of Japanese Patent Application No. 2002-329102, filed on Nov. 13, 2002, the disclosure of which is expressly incorporated by reference herein in its entirety.

### BACKGROUND OF THE INVENTION

1. Field of the Invention

The invention relates to a three-dimensional object fabrication method and apparatus able to fabricate an object with a highly precise surface finish in a short period of time.

2. Description of the Related Art

Rapid prototyping processes that employ a photo-resist, powder forming, or layered sheet forming fabrication technique view the model to be prototyped as a structure having multiple cross sections at closely spaced intervals. The entire model is divided into multiple cross sections running across the Z-axis (vertical direction) at specific intervals, and data pertaining to the shape of each cross section in the model is applied to form a corresponding layer in the prototype structure. This type of three-dimensional object fabrication apparatus is explained in Japanese Laid-Open Patent Application No. H7-256763, at paragraphs 0003, 0004, and in FIGS. 22, 23 thereof, and is also explained in Japanese Laid-Open Patent Application No. H8-318573, at paragraphs 0024, 0029, and in FIG. 4 thereof.

The fabrication method employed by a conventional three-dimensional prototyping machine of this type is shown in FIGS. 3A-3E of the present application. This conventional method initially forms thin layer 92, which includes a water soluble subtractive material, on stage 91 (shown in FIG. 3A) of the prototyping machine. An end milling or laser machining (sublimation) process is then applied to remove specific areas of material from subtractive material layer 92 to form the desired shape of layer 92 (as shown in FIG. 3B).

A specific volume of additive material 94 is then placed into void 93 (as shown in FIG. 3C). Thin layers of subtractive material are applied and specific areas of the subtractive material removed in a repetitive process that eventually forms the structure of the prototype from the filled-in area of each layer (as shown in FIG. 3D). Lastly, layered structure 94 is removed from stage 91 and water washed to obtain three-dimensional object 100 (as shown in FIG. 3E).

The cross section of the object obtained from the known fabrication methods is delineated by the contour lines of two-dimensional cross sections arranged in the vertical direction. The external shape of the object fabricated from these layered cross sections, however, does not accurately reproduce diagonal and curved surfaces (as shown FIG. 3D), but only provides a stepped profile that approximates these surfaces. As a result, prototypes that demand a high level of dimensional precision require post-processes such as NC milling and/or further hand work after initial fabrication.

The need for these types of post-processes have made it difficult to fully automate the prototype fabrication process and to shorten the time required for prototyping. For example, a technician faced with the job of fabricating a prototype on a tight schedule must often work late into the night and suffer from the resulting stress. Moreover, not only has it not been possible to eliminate these shortcomings completely, a method in which the distance between the stepped contour lines of the fabricated prototype is decreased by taking cross sections at smaller intervals will increase fabrication time in proportion to the extent that these intervals are reduced.

### SUMMARY OF THE INVENTION

The present invention solves the aforesaid shortcomings through a three-dimensional prototype fabrication process and apparatus able to automate the process while shortening the overall prototype fabrication time.

The three-dimensional fabrication method prescribed by the invention employs a process in which a first media application device forms a subtractive material layer from an appropriate amount of subtractive material, a three-dimensional machining process is applied to the subtractive material layer, a second media application device forms an additive material layer from an appropriate amount of additive material, and a three-dimensional machining process is applied to the additive material layer, the aforesaid machining process being repetitively executed for each formed layer after which the aforesaid subtractive layers are removed to obtain the desired three-dimensional object.

Because a three-dimensional machining process is continuously applied to the subtractive and additive layers supplied by the fabrication process, the stepped profile of a three-dimensional object fabricated from conventional methods is eliminated along with the need to apply additional post processes.

As a result of these factors, the present invention is able to offer a three-dimensional object fabrication method that shortens total fabrication time. Moreover, in regard to the problem of the inability to directly machine certain parts of three-dimensional forms, the invention is able to apply a direct machining process able to transfer the shape of a subtractive material layer to an additive material layer with a highly precise surface finish, thus eliminating the need to apply additional post-forming processes.

Other aspects of the three-dimensional object fabrication apparatus of the present invention include forming of a subtractive material layer created from an appropriate amount of subtractive material supplied by a first media application device, a first machining device able to machine the subtractive material layer to a three-dimensional shape, the forming of an additive material layer from an appropriate amount of additive material supplied by a second media application device, a second machining device able to machine the additive material layer to a three-dimensional shape, and a control device to repetitively operate the aforesaid first and second machining devices.

The method of the present invention includes forming a first type of material layer with a first media application device, machining the first type of material layer, forming a second type of material layer with a second media application device, machining the second type of material layer, and creating a finished three-dimensional object by repeating the forming and the machining of the first and second types of material layers.

The creating of the finished three-dimensional object may include removing one of said first and said second type of material layer. Additionally, the forming of the second type of material layer may be over the first type of material. Further, The first type of material is a subtractive material and the second type of material is an additive material.

The three-dimensional fabrication apparatus includes a first media application device configured to form a layer of a first type of material, a second media application device configured to form a layer of a second type of material, a first machining device configured to three-dimensionally machine the first and the second type of material, and a controller configured to repetitively operate said first machining device.

A washer configured to remove one of said first and said second type of material layer may also be provided. In another aspect of the invention, the second media application device may be configured to form the layer of the second type of material over the first type of material.

In a further aspect of the invention, a second machining device configured to three-dimensionally machine the second type of material, may be provided, wherein said first machining device is configured to only three-dimensionally machine the first type of material, and said controller is further configured to repetitively operate said second machining device.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates an embodiment of a three-dimensional fabrication machine of the present invention;

FIG. 2A illustrates a first sequential stage of a fabrication method utilized by the three-dimensional fabrication machine of the present invention;

FIG. 2B illustrates a second sequential stage of the fabrication method utilized by the three-dimensional fabrication machine of the present invention;

FIG. 2C illustrates a third sequential stage of the fabrication method utilized by the three-dimensional fabrication machine of the present invention;

FIG. 2D illustrates a fourth sequential stage of the fabrication method utilized by the three-dimensional fabrication machine of the present invention;

FIG. 2E illustrates a fifth sequential stage of the fabrication method utilized by the three-dimensional fabrication machine of the present invention;

FIG. 2F illustrates a sixth sequential stage of the fabrication method utilized by the three-dimensional fabrication machine of the present invention;

FIG. 2G illustrates a seventh sequential stage of the fabrication method utilized by the three-dimensional fabrication machine of the present invention;

FIG. 2H illustrates a eighth sequential stage of the fabrication method utilized by the three-dimensional fabrication machine of the present invention;

FIG. 2I illustrates a ninth sequential stage of the fabrication method utilized by the three-dimensional fabrication machine of the present invention;

FIG. 3A illustrates a first sequential stage of a conventional three-dimensional fabrication process;

FIG. 3B illustrates a second sequential stage of the conventional three-dimensional fabrication process;

FIG. 3C illustrates a second sequential stage of the conventional three-dimensional fabrication process;

FIG. 3D illustrates a third sequential stage of the conventional three-dimensional fabrication process; and

FIG. 3E illustrates a fourth sequential stage of the conventional three-dimensional fabrication process.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

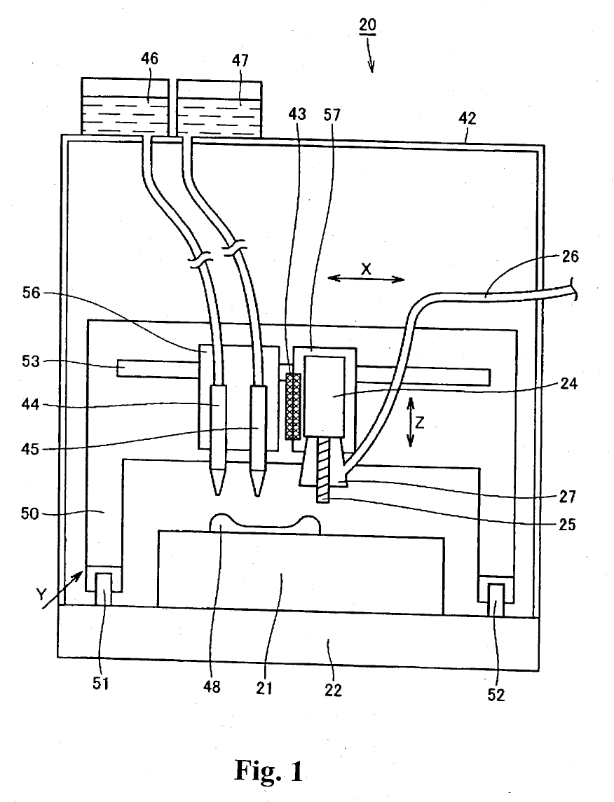

Referring to the drawings wherein like characters represent like elements, FIG. 1 shows an outline drawing of the three-dimensional object fabrication apparatus which is also called a “prototyping machine.”

As illustrated in FIG. 1, a three-dimensional prototyping machine 20 incorporates stage 21 whose upper surface is formed as a horizontal plane. Stage 21 is straddled by gate-shaped traverse frame 50 that is able to move in the fore-aft (Y-axis) direction on traverse rails 51 and 52 that are installed to the upper surface of bed 22. Moreover, dispenser head 56 and machining head 57 move in the X-axis direction along traverse rail 53 which is attached to the upper portion of traverse frame 50. Subtractive material (hereafter termed sub-material) dispenser 44, which is attached to dispenser head 56, and additive material (hereafter termed build material) dispenser 45 move in the Z-axis direction through a traverse power unit (not shown in the figure).

Sub-material tank 46, which supplies the sub-material to dispenser 44, and build material tank 47, which supplies build material to dispenser 45, are attached to the upper portion of plate 42. Both tanks form an integrated structure with dispenser head 56.

Sub-material tank 46 is filled with a water soluble liquid state ultraviolet photo-hardening resin (such as Ultraviolet Hardening Resin 3046B by Three Bond Co.), and build material tank 47 is filled with an insoluble ultraviolet photo-hardening resin (such as Ultraviolet Hardening Resin 3042G by Three Bond Co.). The sub-material and build material supplied by dispensers 46 and 47 respectively, are applied to form the desired shape of prototype 48.

Machining head 57 incorporates spindle 24 and end mill 25 installed to the lower extremity thereon in order to execute a three-dimensional machining process on the Z-axis. The lower portion of spindle 24 is masked by approximately cylindrical cover 27 to which flexible hose 26 is connected to the side thereon. The other end of flexible hose 26 is connected to a vacuum generating device installed externally to prototyping machine 20 as means of removing waste generated by the end mill machining of the sub and build material layers.

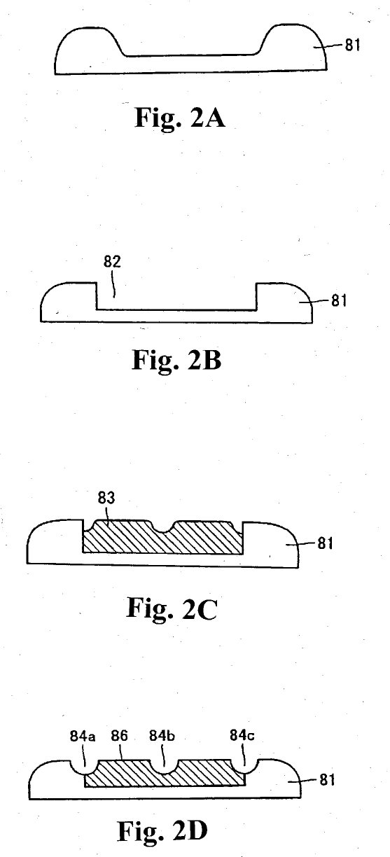

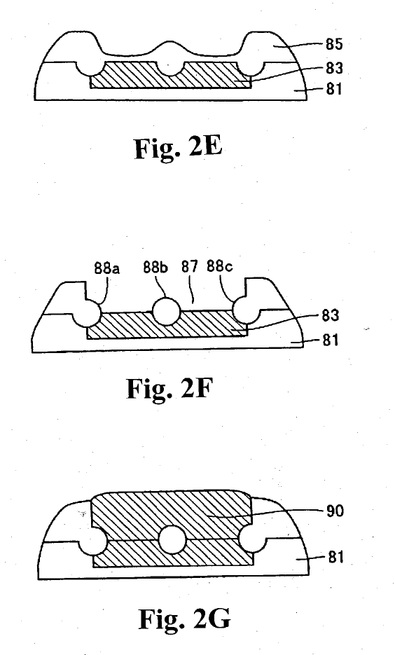

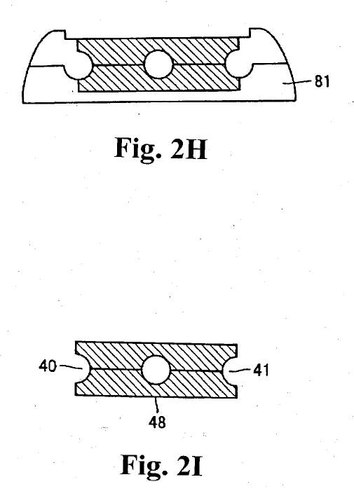

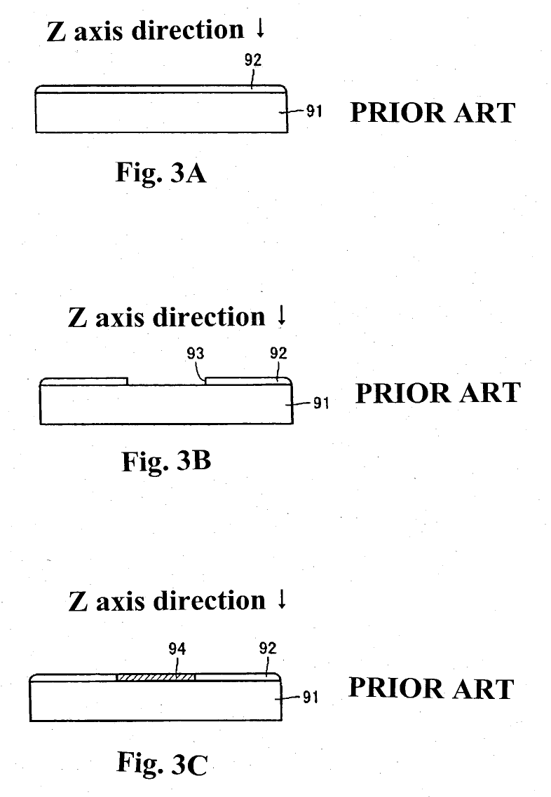

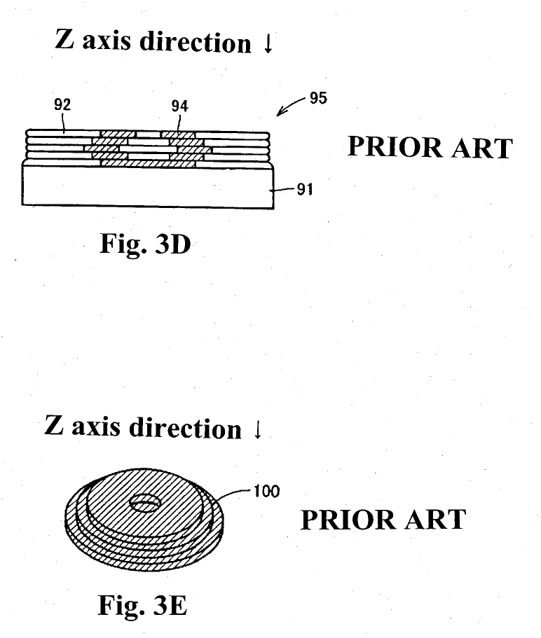

Ultraviolet (hereafter termed “UV”) light source 43 irradiates sub-layer 81 and build layer 83 (which are formed on stage 21—as shown in FIG. 2) with ultraviolet light, and wall 42 is structured to prevent the aforesaid ultraviolet light from escaping the apparatus, and to also prevent light generated by external sources from entering the apparatus.

Referring to FIG. 2, the following discussion will describe the three-dimensional object fabrication process executed by prototyping machine 20 which is shown in FIG. 1. Sub-layer 81 is initially formed on stage 21 by dispenser 44 (FIG. 2A) which deposits the sub-material in a configuration that requires a minimal amount of machining by end mill 25. End mill 25 is operated by a control unit not shown in the figure. Ultraviolet light source 43 then irradiates sub-layer 81 with ultraviolet light to harden the sub-layer structure.

Specific areas of material are removed from sub-layer 81 by end mill 25 to form space 82 which is shown in FIG. 2B. Waste material generated by machining the sub-layer is removed by the vacuum applied to cover 27, through hose 26, by the external vacuum generating machine. Space 82 thus becomes the shape that will be transferred to form bottom part 48 of the completed block-shape that illustrates the fabricated prototype of this embodiment.

Next, build layer 83 is formed within sub-material space 82 by the deposition of build material therein from dispenser 45. In a similar manner as dispenser 44 deposited the previous sub-material layer, dispenser 45 is controlled to deposit an amount of build material that will require a minimal amount of machining. Build layer 83 is then hardened through the irradiation of ultraviolet light from UV light source 43, and as a result becomes a single, unitary integrated structure with sub-layer 81. End mill 25 then machines the surfaces of both sub-layer 81 and build layer 83 to form smoothly surfaced semi-cylindrical channels 84a, 84b, and 84c (as shown in FIG. 2D). Sub-layer 85 is then deposited over semi-cylindrical channels 84a, 84b, and 84c and hardened through irradiation of ultraviolet light from UV light source 43 (as shown in FIG. 2E). Next, end mill 25 machines space 87 out of sub-layer 85 down to original surface 86 of build layer 83, and semi-cylindrical convex form 88b and quarter-round cylindrical convex forms 88a and 88c are machined from the sub-material layer that fills semi-cylindrical channels 84a, 84b, and 84c, as shown in FIG. 2F. Quarter-round cylindrical convex forms 88a and 88c are the shapes that define channels 40 and 41 on each side of the completed block form that illustrates an example of the fabricated prototype for this embodiment.

Build layer 90 is then deposited as a cover layer over space 87 and hardened through ultraviolet light irradiation, as shown in FIG. 2F. The top portions of hardened build layer 90 and sub-layer 85 are then machined with end mill 25, as shown in FIG. 2H.

After machining, supporting sub-layer 81, sub-layer 85, and semi-cylindrical convex form 88b are removed through their dissolution in a water bath, to create the prototype 48, as shown in FIG. 2I. The above-described process thus provides a multi-stage process capable of fabricating a one-piece block form penetrated by a smooth wall cylindrical space.

The prototype fabrication method prescribed by this embodiment deposits only the minimally required amount of sub-material and build material, and thus reduces, to a minimum, the amount of sub-material and build material that must be machined away.

Although the embodiment of the invention described herein makes use of a photo-hardening material as the aforesaid sub-material and build material, the material utilized in the fabrication process is not limited to the photo-hardening type, but may take the form of a 2-part hardening material or a material that hardens at ambient temperatures.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A three-dimensional fabrication method for constructing a three-dimensional object to a desired shape, the method comprising:
forming a first type of material layer with a first media application device;
machining the first type of material layer;
forming a second type of material layer with a second media application device;
machining the second type of material layer;
creating a finished three-dimensional object by repeating said forming and said machining of the first and second types of material layers.

2. The three-dimensional object fabrication method according to claim 1, wherein said creating the finished three-dimensional object comprises removing one of the first and the second type of material layer.

3. The three-dimensional object fabrication method according to claim 1, wherein said forming of the second type of material layer is over the first type of material.

4. The three-dimensional object fabrication method according to claim 1, wherein the first type of material is a subtractive material and the second type of material is an additive material.

5. The three-dimensional object fabrication method according to claim 1, further comprising hardening at least one of said first and said second type of material layer.

6. A three-dimensional fabrication apparatus comprising:
a first media application device configured to form a layer of a first type of material;
a second media application device configured to form a layer of a second type of material;
a first machining device configured to three-dimensionally machine the first and the second type of material; and
a controller configured to repetitively operate said first machining device.

7. The three-dimensional object fabrication apparatus according to claim 6, further comprising a washer configured to remove one of said first and said second type of material layer.

8. The three-dimensional object fabrication apparatus according to claim 6, wherein said second media application device is configured to form the layer of the second type of material over the first type of material.

9. The three-dimensional object fabrication apparatus according to claim 6, further comprising a second machining device configured to three-dimensionally machine the second type of material, wherein:
said first machining device is configured to only three-dimensionally machine the first type of material; and
said controller is further configured to repetitively operate said second machining device.

10. The three-dimensional object fabrication apparatus according to claim 9, wherein said first machining device and said second machining device are configured to alternately three-dimensionally machine a respective of the first and the second type of material.

11. The three-dimensional object fabrication apparatus according to claim 5, wherein the first type of material is a subtractive material and the second type of material is an additive material.

12. The three-dimensional object fabrication apparatus according to claim 6, further comprising an energy source configured harden at least one of said first and said second type of material layer.
